(19) United States
(12) Patent Application Publication
(10) Pub. No.: US 2004/0034966 A1
(43) Pub. Date: Feb. 26, 2004

(54) Cabinet hinge installable by one person

(76) Inventor: Thomas Wegman, Effingham, IL (US)

Correspondence Address: OLSON & HIERL, LTD., 36th Floor, 20 North Wacker Drive, Chicago, IL, 60606, US

(21) Appl. No.: 10/224,119

(22) Filed: Aug. 20, 2002

(51) Int. Cl. E05D 7/10

(52) U.S. Cl. 16/254

(57) ABSTRACT

A hinge and an associated method of use are provided that enable one person to hinge a pivotable member, such as a cabinet door, relative to an aperture in stationary structure, such as a cabinet, or vice versa. The hinge has first and second hinge leaves, and the first hinge leaf is provided with a hanger receiving aperture. After the second hinge leaf is mounted to the pivotable member by screws or the like, the aperture in the first hinge leaf is hung temporarily over a hanger that is preliminarily positioned and mounted in the stationary structure and the first hinge leaf is mounted to the stationary member. The hanger can be a headed protruding screw. After the mounting, the hanger may be removed. Preferably the hinge has hinge leaves each comprised of cooperating, progressive step segments that each terminate in mutually interdigitating, pintle associating knuckle members, and preferably a medial segment of one hinge leaf is nestably received in one segment of the other hinge leaf, thereby providing the hinge with a compact configuration when folded (closed). The segmented leaves enable the hinge to extend over edge portions of a door and adjacent cabinet aperture.

### FIELD OF THE INVENTION

This invention relates to hinges that are adapted for associating a pivotable member, such as a cabinet door, with an aperture in a stationary structure, such as a cabinet, and that can be installed by only one person.

### BACKGROUND OF THE INVENTION

A cabinet is usually assembled and provided with at least one door-associatable opening (or aperture) before a cooperating cabinet door is connected by hinges along a side of the opening. Two or more hinges can be utilized to enable the door to pivot between open and closed positions relative to the opening. After the door is preliminarily mounted to the appropriate first hinge leaves of the selected hinges, more than one worker is usually needed to mount the respective second hinge leaves of the hinges to the adjacent side wall portion of the cabinet opening. For example, one worker may hold and position the cabinet door relative to the cabinet opening in an open door configuration that is aligned with the cabinet opening while a second worker positions and secures the individual hinge leaf mounting screws.

To reduce labor costs and improve the ease of installation, it would be desirable to avoid the need for more than one worker to install a set of hinges. This must be accomplished without sacrificing worker safety, or risking installation error, such as can occur when one worker, even though able and experienced, attempts to mount a prior art cabinet hinge that is already associated with a cabinet door.

Installation labor costs are difficult to reduce with cabinet hinges of the type where the hinge incorporates two hinge leaves which each have respective portions that nestably associate with each other when the hinge is in a closed configuration. Such cabinet hinges are evidently coming into increasing commercial usage and are perceived to be advantageous because of their small thickness when in a closed configuration. Hinges of this type require accurate location and positioning of hinge leaves and hinge leaf mounting which requirement can increase the need for more than one worker in securing a cabinet door to a cabinet.

There is thus a need for an improved hinge, particularly a cabinet hinge, which can be installed by only one person. The present invention aims to fulfill this need.

### SUMMARY OF THE INVENTION

More particularly, the present invention is directed in one aspect to improved hinges that are particularly well adapted for hinging a pivotable member, such as a cabinet door, relative to an aperture in a stationary member, such as a cabinet.

In another aspect, the present invention is directed to a method for hinging a pivotable member, such as a cabinet door, relative to an aperture in a stationary member, such as a cabinet, which utilizes a hinge of the invention and which requires only one worker.

The inventive hinges each incorporate, like prior art hinges, two hinge leaves that are pivotably associated together by cooperating, usually interdigitated, knuckles that have an associated pintle member which permits the hinge leaves to pivot relative to each other. However, in an inventive hinge, at least one of the two hinge leaves is provided with a channel which can be associated with a positioning and supporting member that projects from a predetermined location where the hinge leaf that has the channel is to be mounted. The cooperating channel and projecting member avoid the need for a second worker when mounting the associated hinge leaf. The channel is separate from and in addition to receiving holes in the hinge leaves that are adapted to receive therethrough screws or the like for hinge leaf mounting.

Relative to a hinge leaf member, preferably, the channel is somewhat transversely elongated and is situated so as to be open and accessible from an outside perimeter edge region of the hinge leaf. The channel is adapted to associate with a projecting screw, pin, hook, or like member, and to position and support the involved hinge leaf and components associated therewith when the channel is associated with such member.

A cabinet door, for example, is readily and conveniently hinged to, for example, a cabinet using at least one embodiment of the inventive hinge by practicing the method of use provided by the invention. In accord with a preferred embodiment of this method, as a first step, one selects an approximate location on each of the selected cabinet door, such as at a side edge region of the cabinet door, and the adjacent cabinet wall region of the cabinet where a selected hinge is to be mounted. Conveniently, a selected hinge that has a hinge leaf with the channel defined therein, as indicated above, located against the adjacent cabinet wall and the position of the channel relative to the adjacent cabinet wall region is noted (i.e., marked).

In a next step, one mounts in the cabinet wall region adjacent to the position where the channel will be located when that channel-containing hinge leaf is mounted to the cabinet, a locating and supporting pin member at the marked location. Various types of support pin members may be used, but it is convenient and preferred to employ a headed screw as a channel engaging pin member for positioning and supporting the channel-containing hinge leaf, with the headed screw being advanced incompletely by a screw driver or the like into the cabinet wall location. The channel-containing leaf member preferably has screw-receiving or like holes defined therein.

In a next step, the other hinge leaf of the selected hinge, which leaf is preferably provided with conventional-type screw-receiving holes, but which need not have a pin-receiving channel therein, is mounted by screws or the like to the selected side edge portion of the cabinet door in the predetermined location. The door and associated hinge are then positioned so that the channel in the hinge leaf becomes associated and engaged with the previously mounted supporting pin member, thereby permitting the door and the associated hinge to support and even hang from the cabinet and also positioning the hinge leaf relative to the cabinet wall. Finally, the channel containing hinge leaf is mounted to the cabinet wall in the selected location conveniently employing a plurality of screws or the like that extend through the hinge leaf into engagement with the adjacent cabinet wall.

Conveniently and preferably, the cabinet door and the cabinet wall are predrilled with machine controlled screw-receiving holes at precise locations at the manufacturing location which can simplify the cabinet door hinging procedure. Also, if desired, the locating and supporting pin member can be removed after hinge installation. Various equivalent embodiments and variations in the method can be utilized, if desired, as those skilled in the art will readily appreciate, without departing from the invention.

In an inventive hinge, optionally but preferably, the hinge leaves can incorporate segments or progressive steps, thereby to adapt a hinge for association with the edge region of a particular cabinet door or a particular cabinet wall adjacent to a door receiving aperture provided in a cabinet structure. The respective segmented hinge leaf structures of a given hinge are configured so that, when the hinge is in a hinge closed configuration, adjacent leaf segments of each hinge leaf are cooperatively interfacially engageable with, or in interfacial relationship with, one another.

Also, in an inventive hinge with segmented hinge leaves, preferably an opening or window in one segment of one hinge leaf is adapted to receive therein a portion of one segment of another hinge leaf when the hinge is in a hinge closed configuration. The nesting segments utilize less thickness than two adjacently located segments.

In a presently preferred class of the inventive hinge, the two hinge leaves differ from one another. One hinge leaf has three segments wherein a first and a second segment are each generally flat, and extend in spaced, parallel relationship to each other while the third segment interconnects the first and the second segments along respective adjacent edge portions of the first and the second segments and extends vertically therebetween. The second hinge leaf has two segments wherein the first segment perpendicularly interconnects with the second segment along a common edge portion. The first segment of the one hinge leaf adjoins the first segment of the second hinge leaf, and along the adjoining region each respective first segment defines from one to about three knuckles. The knuckles interdigitate with one another, the knuckles of the one first segment are pivotable relative to the knuckles of the other first segment, and the knuckles of each first segment are interconnected together along their pivot axis by a common pintle. The respective configurations and relationship between the first and the second hinge leaves is such that, when the hinge is in a closed configuration, each of the respective first segments are in face-to-face relationship with the second segment of the second hinge leaf being received in an aperture defined in the third segment of the first hinge leaf.

Various embodiments and alternative equivalent structures for the inventive hinge are contemplated, within the scope of the invention, and will be apparent to those skilled in the art based on the accompanying description.

Thus, other and further objects, aims, purposes, features, advantages, embodiments, equivalent alternatives, and the like will be apparent to those skilled in the art from the teachings of the present specification taken with the accompanying drawings and the appended claims.

### BRIEF DESCRIPTION OF THE DRAWINGS

In the drawings:

FIG. 1 is an environmental elevational front side perspective view of one embodiment of the inventive cabinet hinge showing the cabinet hinge in a closed configuration, with associated illustrative mounting screws, and with portions of an illustrative connected cabinet, and portions of an illustrative connected cabinet door, being illustrated in phantom;

FIG. 1A is a fragmentary elevational perspective view of a portion of one leaf of the hinge of FIG. 1 illustrating a combination of the hinge with preliminarily associated mounting screws;

FIG. 2 is an elevational view of the right side of the FIG. 1 hinge;

FIG. 3 is an elevational view of the left side of the FIG. 1 hinge;

FIG. 4 is a top plan view of the FIG. 1 hinge with the associated screws, and with portions of the connected cabinet and the connected cabinet door being illustrated in phantom;

FIG. 5 is a bottom plan view of the FIG. 1 hinge with the associated screws, and with portions of the connected cabinet and the connected cabinet door being illustrated in phantom;

FIG. 6 is a front elevational view of the FIG. 1 hinge with the associated screws, and with portions of the connected cabinet and the connected cabinet door being illustrated in phantom;

FIG. 7 is a back side elevational view of the FIG. 1 hinge;

FIG. 8 is an elevational perspective view similar to FIG. 1, but showing the hinge in an open configuration, with the associated screws, and with portions of the connected cabinet and portions of the connected cabinet door being illustrated in phantom;

FIG. 9 is an elevational view of the right side of the hinge shown in FIG. 8 with the associated screws, and with portions of the connected cabinet and the connected cabinet door being illustrated in phantom;

FIG. 10 is an elevational view of the left side of the hinge shown in FIG. 8 with the associated screws, and with portions of the connected cabinet and portions of the connected cabinet door being illustrated in phantom;

FIG. 11 is a top plan view of the hinge shown in FIG. 8 with the associated screws, and portions of the connected cabinet and portions of the connected cabinet door being illustrated in phantom;

FIG. 12 is a bottom plan view of the hinge shown in FIG. 8 with the associated screws, and with portions of the connected cabinet and portions of the connected cabinet door being illustrated in phantom;

FIG. 13 is a front elevational view of the hinge shown in FIG. 8 with the associated screws, and with portions of the connected cabinet and portions of the connected cabinet door being illustrated in phantom;

FIG. 14 is a back side elevational view of the hinge shown in FIG. 8;

FIG. 15 is an exploded perspective view of a second embodiment of the inventive hinge showing the hinge in an open configuration, with associated illustrative mounting screws;

FIG. 15A is an assembled perspective view of the hinge embodiment shown in FIG. 15 showing the hinge in a closed configuration;

FIG. 16 is an elevational view of the right side of the FIG. 15A hinge with illustrative associated screws, and with portions of a connected cabinet and a connected cabinet door being illustrated in phantom;

FIG. 17 is an elevational view of the left side of the FIG. 15A hinge with the illustrative associated screws, and with portions of the connected cabinet and portions of the connected cabinet door being illustrated in phantom;

FIG. 18 is a top plan view of the FIG. 15A hinge with the illustrative associated screws, and with portions of the connected cabinet and portions of the connected cabinet door being illustrated in phantom;

FIG. 19 is a bottom plan view of the FIG. 15A hinge with the illustrative associated screws, and with portions of the connected cabinet and portions of the connected cabinet door being illustrated in phantom;

FIG. 20 is a front elevational view of the FIG. 15A hinge with the illustrative associated screws, and with portions of the connected cabinet and portions of the connected cabinet door being illustrated in phantom;

FIG. 21 is a back side elevational view of the FIG. 15A hinge;

FIG. 22 is an environmental elevational perspective view of the cabinet hinge of FIGS. 15 and 15A showing the hinge embodiment in an open configuration, with illustrative associated screws, and with portions of the illustrative connected cabinet, and the illustrative connected cabinet door, being illustrated in phantom;

FIG. 23 is an elevational view of the right side of the hinge of FIG. 22 with the associated screws, and with portions of the connected cabinet and portions of the connected cabinet door being illustrated in phantom;

FIG. 24 is an elevational view of the left side of the hinge shown in FIG. 22 with the associated screws, and with portions of the connected cabinet and portions of the connected cabinet door being illustrated in phantom;

FIG. 25 is a top plan view of the hinge shown in FIG. 22 with the associated screws, and with portions of the connected cabinet and portions of the connected cabinet door being illustrated in phantom;

FIG. 26 is a bottom plan view of the hinge shown in FIG. 22 with the associated screws, and with portions of the connected cabinet and portions of the connected cabinet door being illustrated in phantom;

FIG. 27 is a front elevational view of the hinge shown in FIG. 22 with the associated screws, and with portions of the connected cabinet and portions of the connected cabinet door being illustrated in phantom;

FIG. 28 is a back side elevational view of the hinge shown in FIG. 22;

FIG. 29 is a fragmentary perspective view illustrating the inventive method at the time when one worker is proceeding to position and support one leaf of the hinge of FIGS. 15-28 at an aperture in a cabinet after the other leaf of the hinge has already been associated with a cooperating cabinet door;

FIG. 30 is an enlarged fragmentary perspective view illustrating further the inventive method after completion of the hinge leaf positioning and mounting as shown in FIG. 29, this view showing a fragmentary enlarged portion of the hinge leaf that is associated with the cabinet and illustrating the association of one channel of the hinge of FIGS. 15-28 with a positioning and supporting screw that is preliminarily mounted to the cabinet;

FIG. 31 is a perspective view illustrating still further the inventive method where a so screw positioned and supported hinge leaf of the hinge of FIGS. 15-28 is being fastened by screws to the cabinet;

FIG. 32 is a view showing a third alternative embodiment of a hinge of the invention, the hinge being illustratively in association with exemplary screws, and illustratively connected with portions of an exemplary cabinet and with portions of an exemplary cabinet door which are shown in phantom;

FIG. 33 is a view showing the right side of the hinge shown in FIG. 32 with the associated illustrative screws, and with portions of the connected cabinet and connected cabinet door being shown in phantom;

FIG. 34 is a view showing the left side of the hinge shown in FIG. 32 with the associated illustrative screws, and with portions of the connected cabinet and connected cabinet door being shown in phantom;

FIG. 35 is a view showing a fourth alternative embodiment of a hinge of the invention with associated illustrative screws, and with portions of an illustrative connected illustrative cabinet and portions of an illustrative connected cabinet door being shown in phantom;

FIG. 36 is a view showing the right side of the hinge shown in FIG. 35;

FIG. 37 is a view showing the left side of the hinge shown in FIG. 35;

FIG. 38 is a view showing a fifth alternative embodiment of a hinge of the invention with associated illustrative screws (some being shown in section), and with portions of an illustrative connected cabinet and portions of an illustrative connected cabinet door being shown in phantom;

FIG. 39 is a view showing the right side of the hinge shown in FIG. 38 with the associated illustrative screws, and with portions of the connected illustrative cabinet and portions of the illustrative connected cabinet door being shown in phantom;

FIG. 40 is a view showing the left side of the hinge shown in FIG. 38 with the associated illustrative screws, and with portions of the connected illustrative cabinet and portions of the illustrative connected cabinet door being shown in phantom;

FIG. 41 is a perspective view of a sixth embodiment of a hinge of the invention which utilizes two cooperating L-configured hinge leaves that nestably engage when the hinge is in a closed position;

FIG. 42 is a view showing a top plan view of the FIG. 41 hinge, the hinge being shown with the associated illustrative screws, and with portions of the connected illustrative cabinet and portions of the illustrative connected cabinet door being shown in phantom;

FIG. 43 is a view showing a top plan of the hinge of FIG. 41 but in a closed position with the associated illustrative screws, and with portions of the connected illustrative cabinet and the illustrative connected cabinet door being shown in phantom;

FIG. 44 is a perspective view of a seventh embodiment of a hinge of the invention which utilizes a flat hinge leaf and an L-configured hinge leaf with the latter leaf incorporating a positioning and supporting channel;

FIG. 44A is a rear elevational view of the hinge shown in FIG. 44;

FIG. 45 is a top plan view of the hinge shown in FIG. 44 but in a closed position, the hinge being in association with illustrative screws that are shown in phantom and with an illustrative cabinet and illustrative cabinet that are each shown in transverse section;

FIG. 46 is a view similar to FIG. 45, but showing the hinge opened about 90°;

FIG. 47 is a view similar to FIG. 45, but showing the hinge opened about 180°;

FIG. 48 is a view similar to FIG. 45, but showing the hinge opened about 270°;

FIG. 49 is a perspective view of an eighth embodiment of a hinge of the invention which incorporates two hinge leaves which are each flat and which each incorporate a positioning and supporting channel;

FIG. 50 is a top plan view of the hinge of FIG. 49, the hinge being shown illustratively in combination with screws and also with portions of a cabinet and a cabinet door, all of which are shown in phantom;

FIG. 51 is a view similar to FIG. 50, but showing the hinge in a closed configuration;

FIG. 52 is an environmental perspective view of a ninth embodiment of a hinge of the invention, the hinge being in an open configuration, the hinge incorporating a flat hinge leaf that includes a positioning and supporting channel and an L-configured leaf, the hinge being associated with illustrative connecting screws, and being connected with portions of an illustrative cabinet and an illustrative cabinet door that are shown in phantom;

FIG. 53 is an elevational view of the right side of the FIG. 52 hinge;

FIG. 54 is an elevational view of the left side of the FIG. 52 hinge;

FIG. 55 is a top plan view of the FIG. 52 hinge with the associated screws and connected cabinet and cabinet door being shown in phantom;

FIG. 56 is a front elevational view of the FIG. 52 hinge;

FIG. 57 is a back elevational view of the FIG. 53 hinge;

FIG. 58 is an environmental perspective view of the hinge of FIG. 52 but showing the hinge in a closed configuration, the hinge being associated with illustrative connecting screws, and being connected with portions of an illustrative cabinet and an illustrative cabinet door that are shown in phantom;

FIG. 59 is an elevational view of the right side of the FIG. 58 hinge;

FIG. 60 is an elevational view of the left side of the FIG. 58 hinge;

FIG. 61 is a top plan view of the FIG. 58 hinge with the associated screws and connected cabinet and cabinet door being shown in phantom;

FIG. 62 is a front elevational view of the FIG. 58 hinge;

FIG. 63 is a back elevational view of the FIG. 58 hinge; and

FIG. 64 a fragmentary view of a tenth embodiment of a hinge of the invention which is similar to the FIG. 52 hinge but which has five knuckles instead of three.

### DETAILED DESCRIPTION

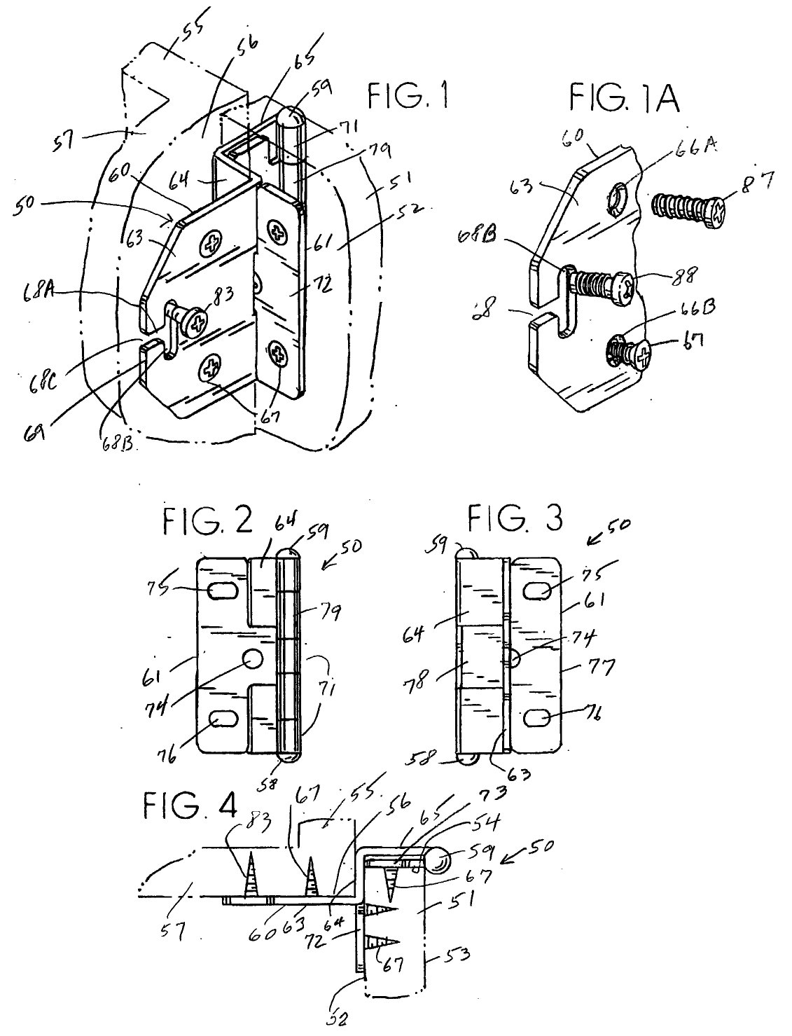

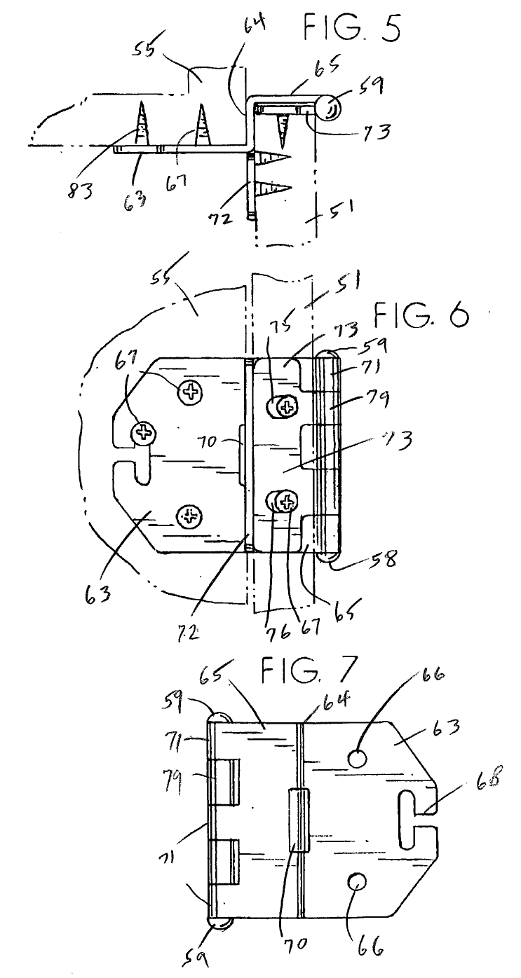

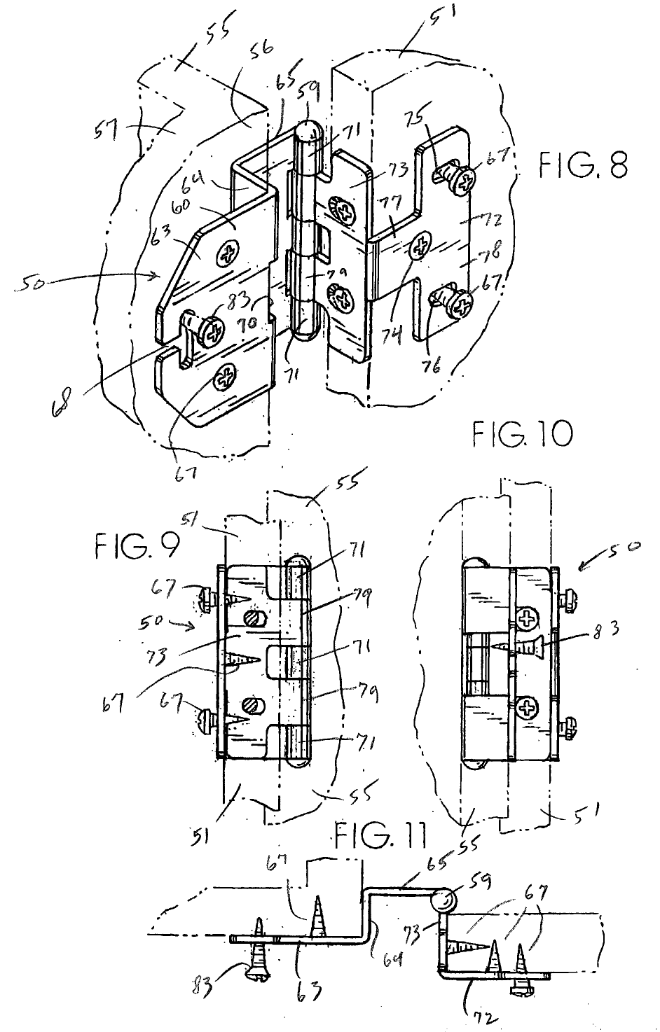

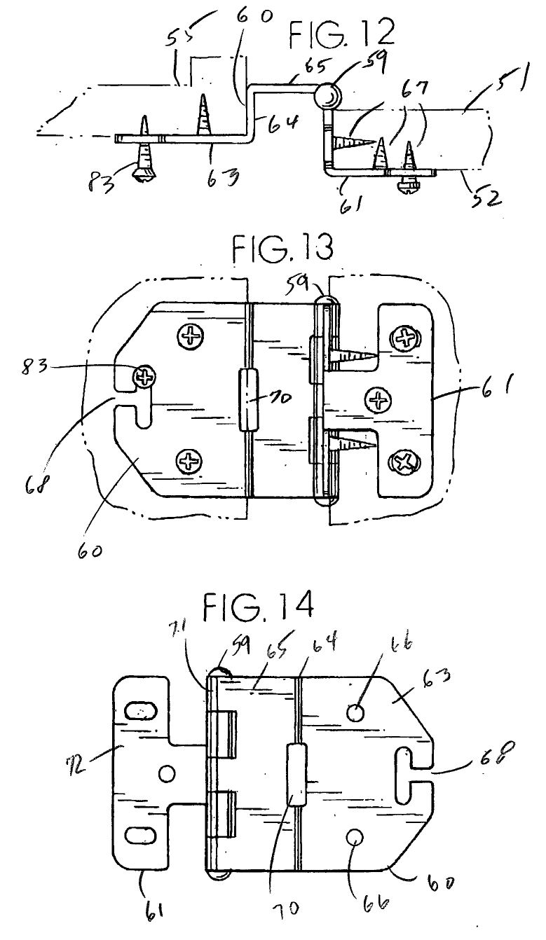

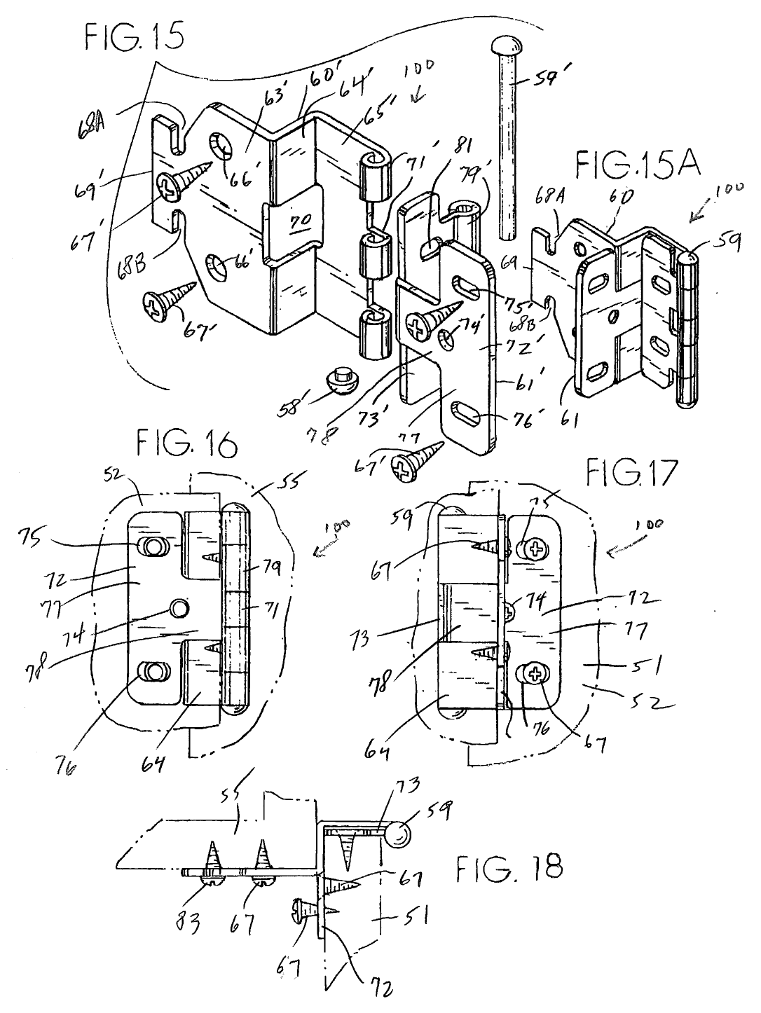

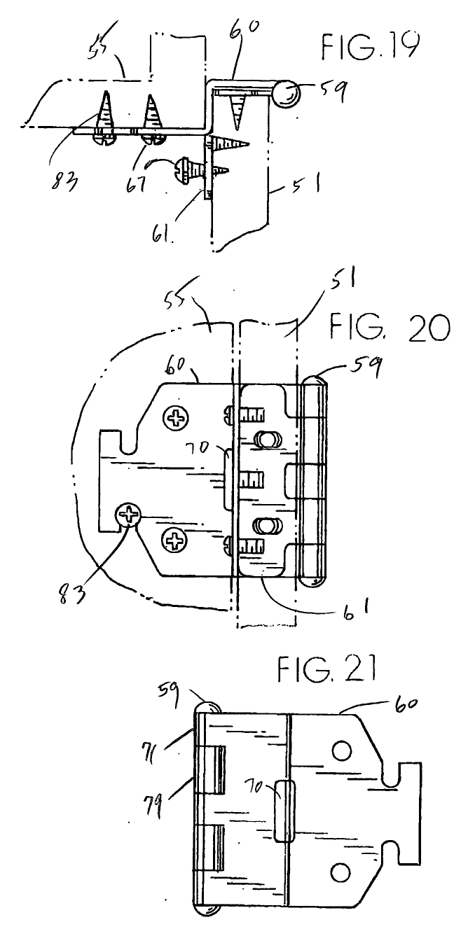

Referring to FIGS. 1-14, there is seen an embodiment 50 of a hinge of the invention. Hinge 50 is particularly well adapted for use in hanging (or hinging) a cabinet door relative to a cabinet aperture for opening and closing swinging movements of the door relative to the aperture. Here, an illustrative cabinet door 51 (fragmentarily shown in phantom) has respective inside and outside faces 52 and 53, and a back side edge 54. The front side edge, top side edge, and bottom side edge are not detailed. An illustrative cabinet 55 (fragmentarily shown in phantom) has an aperture 56 that includes a side piece 57 located along and defining the edge region of aperture 56. More than one hinge 50 may be employed, if desired (not detailed), to hinge the door 51 relative to the cabinet 55. Hinge 50 can be conventionally fabricated of metal (preferred) or plastic. The cabinet 55 and the cabinet door 51 are conventional and can be comprised of conventional materials. For example, cabinet 55 and cabinet door 51 may have cores comprised of a fiberboard or particle board that is adapted to receive and hold wood-type screws that may be advanced thereinto for purposes of mounting and supporting hinges, such as hinges 50.

The hinge 50 includes a hinge pintle 59, a first hinge leaf 60 with knuckles 71, and a second hinge leaf 61 with knuckles 79. The first hinge leaf 60 includes three integral progressively located segments, identified as flattened first segment 63, flattened second segment 64, and flattened third segment 65. The first segment 63 has a plurality (illustratively two, as shown, for example, in FIGS. 7 and 14) of conventional circular holes 66 defined therein for receiving therethrough fasteners (mounting means), such as headed screws 67 or the like, that mount the first segment 63 and the first hinge leaf 60 to the side piece 57 adjacent to an edge region of the aperture 56 of the cabinet 55.

First segment 63 has a somewhat transversely (relative to first segment 63) elongated and relatively narrow channel 68 defined therein that includes (see, for example, FIG. 1) an opening 68C which opens outwardly at a medial rear side edge extension portion 69 of first segment 63. Channel 68 includes an inwardly extending channel portion 68A that extends inwardly (relative to first segment 63) a relatively short distance and that connects terminably with a mid-region of a generally longitudinally extending portion 68B. To provide enhanced access to, and a connecting base region for, the channel 68, the first segment 63 here includes preferably in its rear side edge extension portion 69 in which the channel 68 is mainly defined. The functioning of the channel 68 is considered hereinbelow. Except for the rear side edge portion 69, the leaf segments 63, 64, and 65 each may be considered to have preferably a generally rectangular perimeter configuration.

Considering the pintle 59 for present descriptive purposes to be the central region of hinge 50, the rear side of the second leaf segment 64 of the first hinge leaf 60 joins the forward side of the first leaf segment 63 and the second leaf segment 64 extends perpendicularly relative to the first leaf segment 63. The length and width of the second segment 64 are such as to permit the segment 64 to overlie an edge region of the aperture 56 in cabinet 55. The second segment 64 has defined in a medial location thereof a relatively large opening 70 that extends across the width of the second segment 64 and that preferably has, as shown (see, for example, FIG. 10) a rectangular configuration.

The rear side of the third leaf segment 65 of the first hinge leaf 60 joins the forward side of the second leaf segment 64 and extends perpendicularly outward relative to the second leaf segment 64.

Along the forward side of the third leaf segment 65, a plurality of spaced knuckles 71 (illustratively, three as shown, for example, in FIG. 8 or 9) are located that extend generally parallel to a (hypothetical) plain defined by the third segment 65 and also generally parallel to the second segment 64.

The second hinge leaf 61 includes two integral segments, a flattened first segment (or portion) 72, and a flattened second segment (or portion) 73 (see, for example, FIGS. 8 and 14). The first portion 72 defines first and second transversely adjacent, edge interconnected regions 77 and 78. Region 77 is medially located adjacent to the forward edge region of first portion 72 and has a reduced length relative to the rearward second portion 73.

The second hinge leaf 61 has a plurality (three as shown, for example, in FIGS. 8 and 14) of holes, such as holes 74, 75 and 76, that are defined therein for receiving therethrough fasteners (mounting means), such as headed screws 67 or the like, that mount the second hinge leaf 62 to the inside face 52 of the cabinet door 51 adjacent to the back side edge 54 thereof. Here, the hole 74 is medially positioned in the second hinge leaf 61 while the holes 75 and 76 are located in the region 78. Hole 74 has a round configuration, while the holes 75 and 76 are generally adjacent to the rear or outside edge region of the first leaf segment 72, and are in longitudinally (relative to the length of the first segment 72) aligned relationship relative to each other. The holes 75 and 76 are preferably each transversely somewhat elongated (relative to width of the first segment 72) and are preferably in longitudinally spaced, aligned relationship relative to each other.

The forward narrow region 77 has a reduced length so that the first segment 72 in this region or portion 77 has a reduced length and width relative to the rearward region 78 of the first segment 72 that is located adjacent to the rear or outside edge region thereof. The dimensions of the narrow region 77 of the first segment 72 of the second hinge leaf 61 are such as to permit the region 77 to be received in the opening 70 defined in the second segment 64 of the first hinge leaf 60, as explained below. Except for region 77, each segment 72 and 73 may be considered to have preferably a generally rectangular perimeter configuration.

The rear side of the second leaf segment 73 of the second hinge leaf 61 joins the forward side of the first leaf segment 72 and the second leaf segment 73 extends perpendicularly relative to the first leaf segment 72. The length and width of the second segment 73 are such as to permit the leaf segment 73 to overlie a portion of the back side edge 54 of the cabinet door 51. The second leaf segment 73 is optionally but preferably also provided with holes for extending fastening mounting members therethrough, such as screws 67 or the like thereby to mount the second leaf 61.

Various hole arrangements can be provided in the leaves 60 and 61 of hinge 50 for purposes of hinge mounting. An optional but presently preferred arrangement is to longitudinally space a pair of cross-sectionally round holes 66 in aligned relationship relative to each other through the first segment 63 of first hinge leaf 60, as illustrated, for example, in FIG. 7. If desired, elongated holes, preferably longitudinally elongated (not shown for hinge 50, but see hinge 150, for example, in FIG. 41), may be provided in first segment 63 of leaf 60, or the like. An optional but presently preferred arrangement is to provide the second leaf segment 73 of second hinge leaf 61 with holes 81 and 82 that are each medially located (relative to the width of second segment 73), that are preferably transversely elongated (relative to the second segment 73), and that are in longitudinally aligned, symmetrical relationship (relative to the length of second segment 73) relative to each other. The holes 81 and 82 are adapted for receiving therethrough fasteners (mounting means), such as headed screws 67 or the like, that mount the second leaf segment 73 and hinge leaf 62 to the back side edge 54 of the cabinet door 51 adjacent to the inside face 52 thereof. An optional but presently preferred arrangement is to provide the first leaf segment 72 of second hinge leaf 61 with holes 75 and 76 that are in longitudinally spaced, aligned relationship with each other.

The feature that elongated holes, such as holes 81 and 82 in second segment 73, and elongated holes, such as holes 75 and 76 in first segment 72, can coact permits adjustment of the position of the second hinge leaf 61 relative to a cabinet door 51 when these holes are associated with mounting screws or the like.

Along the forward side of the second leaf segment 73, a plurality of slightly forwardly projecting spaced knuckles 79 (two as shown, for example, in FIG. 8) are located that extend generally parallel to a (hypothetical) plain defined by the second segment 73 and also generally parallel to the first segment 72. As embodiments of the inventive hinge provided herein illustrate, a hinge of the invention can have various numbers of, and configurations for, the hinge knuckles, as those skilled in the art will readily appreciate.

In the assembled hinge 50, the knuckles 79 of second leaf segment 73 of the second hinge leaf 61 interdigitate with the knuckles 71 of the third segment 65 of the first hinge leaf 60. The pintle 59 is conventional and can be variously constructed and associated with the hinge leaves of an inventive hinge. Here, the pintle 59 extends longitudinally through the aligned, interdigitated knuckles 71 and 79 whereby the leaves 60 and 61 are pivotable relative to each other and relative to the axis of the pintle 59. The lowermost knuckle 71 may, as shown, be provided with an optional pintle cap 58 (see FIG. 15) for esthetic purposes, if desired. If desired, the pintle 59 can be permanently associated with the knuckles 71 and 79 by conventional manufacturing procedures, such as knurling, swaging, or the like, as those skilled in the art will readily appreciate.

In the hinge 50, the interrelationship between the first hinge leaf 60 and the second hinge leaf 61 is such that, when the hinge 50 is in a closed configuration, the second segment 73 of the second hinge leaf 61 is adjacent to the third segment 65 of the first hinge leaf 60, and the narrow portion of the first segment 72 of the second leaf 61 is nestably received within the opening 70 in the second segment of the first leaf 60. When the first hinge leaf 60 is mounted to the cabinet 55 adjacent to a portion of the aperture 56, and the second hinge leaf 61 is mounted to the cabinet door 51 along a portion of the inside face 52 of the cabinet door 51 and adjacent to a portion of the back side edge 54 of the cabinet door 51, the edge adjacent portions of the inside face 52 of the cabinet door 51 overlie outside edge adjacent portions of the aperture 56 of the cabinet 55 when the hinge 50 is in a closed configuration, as shown, for example, in FIGS. 4 and 5.

In place of screws 67, other types of mounting members can be used, if desired, as those skilled in the art will appreciate, such as nails, sheet metal screws or rivets (as in the case of a cabinet or cabinet door constructed of sheet metal), or the like. As is typical of hinges of the invention, the hinge 50 can be used with various mounting screws, as those skilled in the art will readily appreciate.

For example, in place of tapered wood-type screws 67 (or 83), as illustrated in FIG. 1A, channel 68 and holes 66 can be threadably and preliminarily associated with modified machine screws, such as, for example, the screws 88 and 87, respectively, by an installer of a hinge 50, or by a manufacturer or supplier of hinge 50 who conveniently and preferably employs appropriate automatic machinery, or otherwise. Screws, such as screws 87 and 88, are characterized by having a shank portion that is of generally uniform diameter and that is threaded. Thus, the threaded portion adjacent to the forward end portion of the shank of a screw 88 is threadably associated with, for example, an upper interior end portion of the longitudinally extending portion 68B of channel 68. The threaded portion adjacent to the forward end region of the shank of a screw 87 is threadably associated with, for example, a hole 66A in the first segment 63 of first hinge leaf 60. For illustration purposes, a hole, such as the hole 66B as shown in FIG. 1A may be provided with a tapered entry face, thereby to permit, if desired, the hole 66B to receive in a counter-sunk manner portions of the head of a wood type screw 67 having a tapered shank that is extended through the hole 66B.

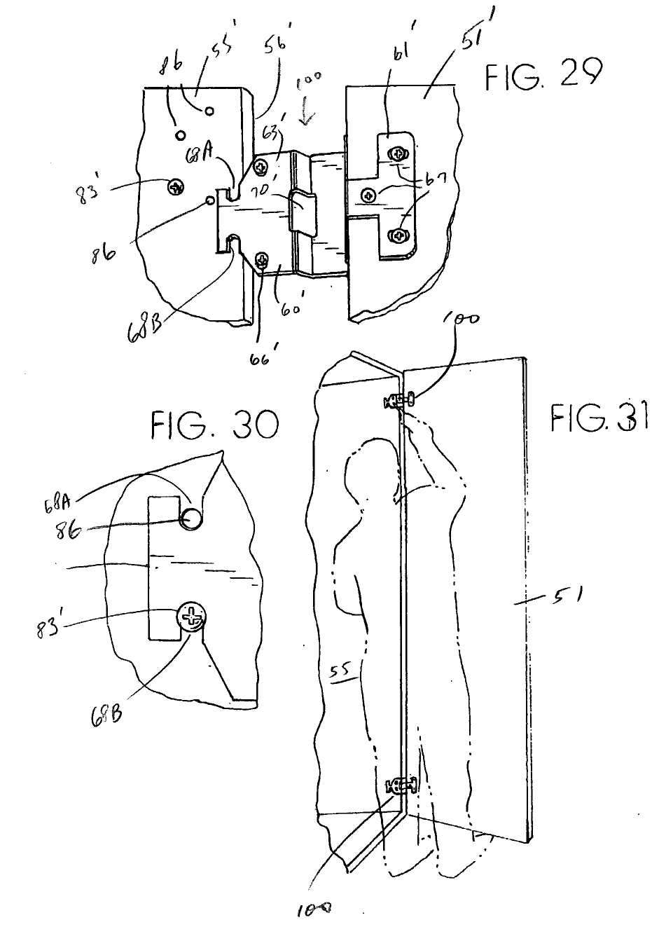

When, for example, the first segment 63 of first hinge leaf 60 is being mounted to a cabinet, such as cabinet 55, as is achieved in the practice of the method of the invention, as further described below, a screw 88 that has preferably been initially threadably associated with the channel 68, and preferably after a suitable predrilled hole 86 in side piece 57 of aperture 56 of cabinet 55 is aligned therewith, as described below, is conveniently advanced into cabinet 55 by a powered screw driver or the like (see, for example, FIGS. 29 and 30), thereby to locate preliminarily, and to support and position, the first hinge leaf 60, relative to the cabinet 55. Thereafter, each screw 87 that has preferably been initially threadably associated with a hole 66 is threadably advanced into engagement with a preferably aligned, predrilled hole 86 in the cabinet 55 until the head of each screw 87 engages adjacent surface portions of the first hinge leaf 60. After the screws 87 have so mounted the first hinge leaf 60, the screw 88 can either be advanced through the first hinge leaf 60 until the head thereof engages adjacent surface portions of the first hinge leaf 60, or be retracted (separated) from the first hinge leaf 60, as desired. When so advanced, the screw 88 aids in mounting the hinge 50 to a cabinet 55.

Conveniently and preferably, the threaded shank portion of a screw 87 that has been preliminarily threadably engaged at its forward end region with a hole 66 and that has been advanced through the hole 66 and into threaded engagement with a preformed hole 86 in a cabinet 55 or the like, so that the screw 87 head is contacting the leaf adjacent to the hole 66, remains threadably engaged with the hole 66, thereby helping to support and mount the hinge 50. Alternatively, if desired, a screw 88 can be preliminarily associated with a hole 66. Then, when the screw 88 is fully advanced through the hole 66, the screw 88 is not threadably engaged with the hole 66 because the screw 88 threads are discontinuous adjacent the screw 88 head (as shown in FIG. 1A) so that when the shank of a screw 88 is fully extended into a cabinet 55 the fully engaged screw 88 is not threadably associated with the hole 66.

When the screw 88 that has been preliminarily threadably engaged at its forward end region with a channel 68 is advanced fully through the channel 68 and into the cabinet 55 so that its head engages adjacent portions of the first segment 63, the upper end portion of the shank of the screw 87 becomes threadably disengaged from the adjacent channel 68 surface portions. This result occurs because, as illustrated in FIG. 1A, the threads on the screw 88 are discontinuous adjacent the head thereof, as shown in FIG. 1A. In such disengaged condition, the channel 68, and hence also the first segment 63 and first leaf 60, are slidably movable relative to the mounted screw 88 and hence also the cabinet 55, such as may be desired for leaf 60 position adjustment purposes relative to cabinet 55 during the mounting of a hinge 50 relative to a cabinet 55 or the like. Thus, a slight loosening of a previously tightened screw 88 in a channel 68 permits the hinge 50 to be moved relative to the screw 88 as may be desired for hinge 50 adjustment purposes relative to a cabinet 55 or the like.

In a presently preferred practice of the invention, the mounting holes in a hinge 50 are preliminarily threadably associated with the forward end regions of screws whose shanks have threads which are not tapered like wood screws, such as screws 87 and 88. Not only does such an association aid in reducing the labor and time associated with the installation of a hinge 50, but also such a preliminary association of screws with mounting holes facilitates and enhances the practice of the hinge installation method achieved by this invention, as described herein.

The hinge 50 can be employed in practicing the method of hinge installation provided by the present invention. Thus, when the cabinet door 51 is to be hung relative to a cooperatable aperture 56 in the cabinet 55, the following steps are preferably taken: Initially, the approximate reciprocal or corresponding locations on each of the door 51 and the cabinet 55 where a hinge 50 is to be associated are selected.

Next, at least one locating and supporting pin member, preferably a headed screw member 83, or a screw member 88, such as exemplified in FIGS. 1 and 1A, can be selected and mounted. A screw member 83 is preliminarily mounted at a selected location in a side wall portion of the cabinet 55 adjacent to the aperture 56 in a position over which the channel 68 will be situated when the hinge 50 is fully mounted to the cabinet 55 and the cabinet door 51. A screw member 88 is preferably preliminarily associated with the hinge 50 and is preferably advanced into a predrilled channel, such as a hole 86 that is preliminarily made at a selected location in a side wall portion of the cabinet 55 adjacent of the aperture 56 where the hinge 50 is to be fully mounted. Other types of pin members can be used, if desired, as those skilled in the art will appreciate, such as nails, hooks, such as members terminating in an exterior L-configuration, rivets (as in the case of a cabinet constructed of sheet metal), or the like. For example, when the pin member is a headed screw member 83 or 88, the screw member 83 or 88 is threadably associated with the indicated cabinet 55 wall portion and is rotatably turned until only a relatively short section of the screw shank adjacent to the screw head remains extended beyond (outside) the cabinet 55 wall portion. In general, the pin member selected needs to have the capacity to hold and support a first hinge leaf 60 when and while the second hinge leaf 61 is fully associated with the cabinet door 51 (in a preceding mounting operation), and also the pin member, as associated with the cabinet 55, needs to be associatable with the channel 68 for purposes of positioning and supporting a hinge 50 and associated components relative to a cabinet 55.

When channel 68 is positioned and supported by the pin member, the second segment 64 is adjacent an edge portion of the aperture 56. Thus, the second segment 64 cooperates with the first segment 63 in positioning and supporting the first hinge leaf 60 relative to the cabinet 55.

The location for preliminarily installing a positioning and supporting pin member in a cabinet 55, or in a leaf 60, is most preferably selected so that a portion of the channel 68 of a hinge 50 is located adjacent to a predetermined position along the cabinet 55 so that the pin member, as advanced into the cabinet 55 at that location, is adapted to support and position the leaf 60 and components associated therewith, as those skilled in the art will readily appreciate. For example, in the case of channel 68 in leaf 60, a present preference is to so position a location of the channel 68 relative to a cabinet 55 that the first segment 63 serves as a hanger for association with a screw 83 or 88. In achieving such association between a channel 68 and a screw 83, one can, for example, slide the channel 68 over the screw 83 beginning at the opening 68C and move the leaf 60 relative to the screw 83 until the screw 83 is located at a desired location in and along channel 68.

The second hinge leaf 61, in accord with the preferred practice of the method of this invention, is preliminarily mounted to the cabinet door 51 at a selected inside face 52 location and adjacent back side edge 54 location thereof, conveniently using holes in the second hinge leaf 61, such as the holes 74, 75 and 76, and cooperating fastening members, such as headed screws 67, or 87, or the like, that are each in association with an individual such hole. The holes 81 and 82 can also be associated with mounting screws to mount hinge leaf 61 to the cabinet door 51.

Next, the channel 68 of leaf 60 is either positioned over the pin member, preferably the screw 83, that has been mounted at the selected location in the cabinet 55 or the first leaf 60 is located at the selected location in the cabinet 55 and a pin member, preferably a screw such as a screw 88 that has been preliminarily threadably associated with the first leaf 60, is advanced threadably and preferably into an aligned, preformed hole, such as a hole 86, in the cabinet 55. The leaf 60 is preferably in assembled association with hinge 50 components, including the leaf 61, pintle 59 and also with a cabinet door 51 to which the leaf 61 has been already mounted.

Next, the leaf 60, as duly positioned and supported by a pin member, such as a screw 83 or 88, or some alternative pin member, is mounted to the cabinet 55 in the selected position preferably using a plurality of fasteners, preferably using headed screws, such as screws 67 or screws 87, or alternative screws, that each extend through a different suitable hole 66 in segment 63.

Optionally, thereafter, the screw 83, or the screw 88, if employed as the positioning and supporting pin member, can be advanced through the segment 63 until screw head becomes engaged with the segment 63. Alternatively, if desired, the screw 83 can be removed after fasteners such as screws 67 have been engaged and mount the leaf 60.

For hinge installing convenience, accuracy and saving of time in practicing the installing method, self-threading, screw receiving holes, such as holes 86, or the like, may be, and preferably are, positioned and predrilled in the cabinet 55 and/or in the cabinet door 51 at the predetermined locations in which a hinge leaf, such as those of a hinge 50 of the invention, is to be installed. For example, a cabinet or cabinet door manufacturer can use, for example, precision jigs, automatically operating equipment, computer controls, and/or the like, as those skilled in the art will appreciate.

Installation of a hinge or hinges of the invention can be carried out a fabrication site, at a cabinet installation site, or elsewhere, as desired. For example, a cabinet installation site may be desirable as a location for the practice of the inventive hinge installation procedure, as when, for example, a cabinet door customer has selected a particular type or style of cabinet door from among a plurality of cabinet doors for use with a given cabinet.

Also for installing convenience, accuracy and saving of time in practicing the present installation method, screws, such as screws 67, 87, or the like, are preferably preliminarily threadably associated with holes 62 and 66. Thereby, the time and need to preliminarily locate and threadably associate a screw member with a hinge leaf during hinge installation is avoided. Preferably, the preliminarily threading involves a forward end-adjacent region of a mounting screw member so that the forward end of the screw member is in non-interfering relationship with a leaf surface that is subsequently located adjacent to a cabinet wall or a cabinet door, for example.

A hinge of the invention can be employed in combination with various types of mounting means to practice the inventive hinge installation method. However, screws are presently preferred, such as the screws 67 and 87, above illustrated and described. A present preference for achieving the practice of the method of this invention is to utilize hinges with preliminarily threadably associated screws in combination with prepositioned and predrilled holes in a cabinet and in a cabinet door for installation of a hinge of the invention.

Those skilled in the art will appreciate that variations in the order and arrangement of the combination of hinge installation method steps achieved here can be employed, and that variations in particular method steps can be utilized, without departing from the spirit and intent of the present inventive method of hinge installation using a hinge of the invention. For example, when predrilled screw receiving holes are provided before hinge 50 installation, a leaf 61 can be mounted to a cabinet door with screws, such as screws 87, or the like, before the leaf 60 is mounted in a cabinet 55. Although preferentially in the practice of the hinge installation method a cabinet door is preliminarily mounted to a hinge of the invention before the hinge is mounted to a cabinet, this order of procedure may be reversed, if desired or needed, as those skilled in the art will readily appreciate, without departing from the spirit and scope of the invention.

Also, those skilled in the art will readily appreciate that the inventive method can be practiced with various embodiments of hinges of the invention and with various means for fastening a hinge of the invention to surface portions of a cabinet or a cabinet door. The hinge installation method of the invention permits an embodiment of the inventive hinge to be installed by only one worker.

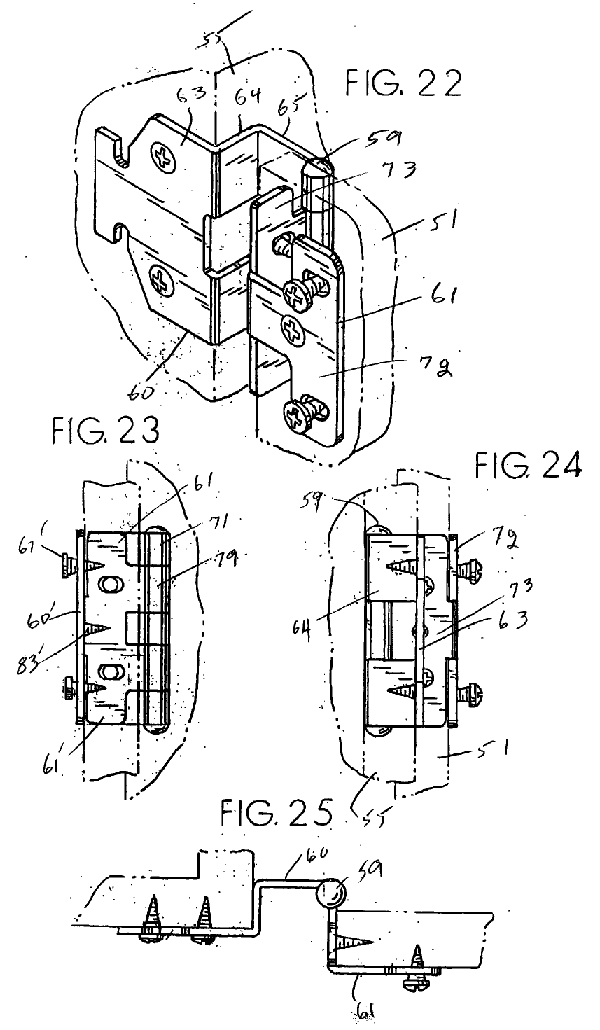

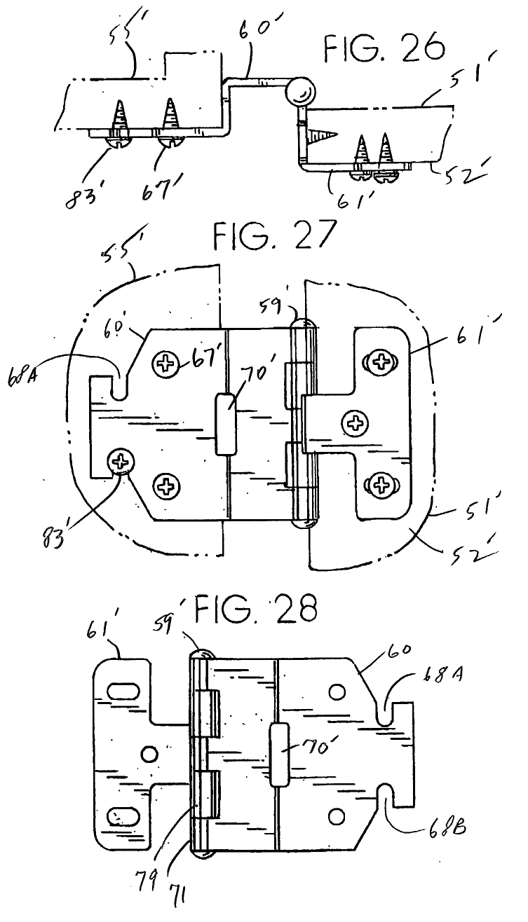

Referring to FIGS. 15-28, there is seen a second embodiment 100 of a hinge of the invention. Since portions of the hinge 100 can be considered to correspond to portions of the hinge 50, for convenience, such corresponding portions of the hinge 100 are similarly numbered but with the addition of prime marks thereto for identification purposes.

A principal difference between hinge 50 and hinge 100 is that the first segment 63′ of the first hinge leaf 60′ of the hinge 100 is modified to include two separate and independent channels 68A and 68B instead of one channel 68 as in the first segment 63 of the first hinge leaf 60 of the hinge 50. Providing the two channels 68A and 68B may increase the number of locations in an apertured cabinet or the like where the hinge 100 can be employed (compared to the hinge 50) in combination with a cabinet door, or the like, particularly in some locations or situations where the hinge 50 may not be suitable or usable, owing, for example, to structural circumstances, such as, for example, cabinet geometry or structure or arrangement.

Like the hinge 50, the hinge 100 is employed in practicing the method of use provided by the present invention. Thus, the second leaf 61′ of a hinge 100 can be mounted by screws 67′ or 87′ first to a cabinet door 51′ and then the first leaf 60′ of the hinge 100 can be mounted to a cabinet 55 by assembly steps such as hereinabove taught.

An illustrative example of the utilization of predrilled, suitably located holes 86 in the side piece 57′ of cabinet 55′ for mounting a hinge 100 is shown in FIGS. 29 and 30. Here, illustratively, a locating and positioning screw 83′ is set threadably into a suitably positioned hole 86 defined in the side piece 57′ of an aperture 56′ of cabinet 55′, and the channel 68B of first segment 63′ of first leaf 60′ of the hinge 100 is located and associated with the screw 83′. The cabinet door 51′ has (illustratively) been previously mounted to the second leaf 61′ of the hinge 100 cabinet door 51′ is positioned and engaged with the locating screw 83′. Thereby, the first leaf 60′ is supported and positioned on the cabinet 55′ with the first segment 63′ against the side piece 57′ of the cabinet aperture 56′ in cabinet 55′ with the second segment 64′ supportively resting against the edge of side piece 57′. Preferably, modified machine-type screws, such as screws 87′ (see FIG. 1A), that have preliminarily had their respective forward end portions threadably associated with holes 66B′ in first segment 63, are thus aligned with respective aligned predrilled holes 86 in cabinet 55′, and these screws 87′ are then advanced conveniently by a powered screw driver into the respective aligned holes 86, thereby mounting the first leaf 60′ to the cabinet 55′ as desired. If a screw 88′ has been preliminarily associated with the channel 68B, then, alternatively, the screw 83′ can be replaced by the screw 88′ (see FIG. 1A), and the screw 88′, after alignment of channel 68B with a suitably provided aligned hole 86, can be advanced into such hole 86 preferably with a powered screw driver (not shown). After the screws 87′ have been mounted through the holes 66 into the cabinet 55, the screw 83′ or 88 (which ever is employed) can either be removed or advanced until engaged with the first segment 63′, thereby aiding in the mounting of the first hinge leaf 60′ to the cabinet 55′.

Initially, the approximate reciprocal or corresponding respective locations on each of the door 51′ and the cabinet 55′ where a hinge 100 is to be associated are selected.

Next, a locating and supporting pin member, preferably a headed screw member 83′ or 88′ (preferred), such as exemplified in FIGS. 29 and 30, is selected and mounted in the wall portion of the cabinet 55′ adjacent to the aperture 56′ in a position over which, illustratively, the channel 68B will be situated when the hinge 100 is fully mounted to the cabinet 55′ and the cabinet door 51′. Other types of pin members can be used, if desired, as those skilled in the art will appreciate, such as nails, hooks, such as hooks that terminate in an exterior L-configuration, rivets (as in the case of a cabinet constructed of sheet metal), or the like. For example, when the pin member is a headed screw member 83′, the screw member 83′ is threadably associated with the indicated cabinet 55′ wall portion and is rotatably turned until only a relatively short section of the screw shank adjacent to the screw head remains extended beyond (projecting from) the cabinet 55′ wall portion. In general, the pin member selected needs to have the capacity to hold and support a first hinge leaf 60′ when and while the second hinge leaf 61′ is fully associated with the cabinet door 51′, and also the pin member (illustratively here the screw member 83′), as associated with the cabinet 55′, needs to be associatable with a channel, such as channel 68B, of leaf 60′.

The location for installing screw member 83′ in cabinet 55′ is most preferably selected so that a portion of a selected channel 68A or 68B is located adjacent to and aligned with the screw member 83′ so as to support and position the leaf 60′ and components associated therewith, as those skilled in the art will readily appreciate.

For convenience, accuracy and saving of time in installing a hinge 100 or the like, holes, such as holes 86, preferably may be predrilled, preferably automatically and with computer controls, for example, at the cabinet 55′ and the cabinet door 51′ fabrication site, for screws, such as screws 67′ and screw 83′, using precision jigs and related equipment at precise, predetermined locations in each of the cabinet 55′ and the door 51′. Installation of hinges of the invention can be carried out at a cabinet or cabinet door fabrication site or installation site or the like. The latter location for the practice of the presently provided installation procedure may be desirable when, for example, a customer has selected various cabinet doors for use with a given cabinet, and the cabinet and selected doors are shipped to the installation site for assembly.

For example, in the case of channel 68B in leaf 60′ of hinge 100, a present preference is to so position the location of the channel 68B relative to a mounted screw 83′ that, when the screw 83′ is fully engaged with the channel 68B, the holes 66′ in the first segment 63′ of first hinge leaf 60′ are located over predrilled holes 86 in the cabinet 55′ in aligned relationship so that individual mounting screws 67 or the like can be extended through the holes 66′ and engaged with and advanced into the adjacent side wall portion of the cabinet 55, thereby positioning and supporting the first segment 63′ at a desired, prechosen location.

Next, the second hinge leaf 61′ is mounted to the cabinet door 51′ at the selected back side edge-adjacent location conveniently using the holes 74′, 75′ and 76′ and a fastening member, such as a headed screw 67′, or the like, in association with each hole.

Next, as illustrated in FIG. 29, the channel 68B of leaf 60′ is positioned over the pin member, preferably the screw 83′, the leaf 60′ being in assembled association with the leaf 61′, the pintle 59′ and the cabinet door 51′. In achieving such an association between channel 68B and screw 83′, one can slide the leaf 60′ over the adjacent surface portions of the cabinet 55′ so that the screw 83′ is admitted into the channel 68B.

Next, the leaf 60′, as duly positioned by the screw 83′, is firmly mounted to the cabinet 55′ in the selected position preferably using a plurality of fasteners (or mounting means), preferably using headed screws, such as screws 67′ or the like, that each extend through a different hole 66′ in segment 63′ and preferably engage a predrilled hole 86 in cabinet 55′.

Optionally, the screw 83′, if employed as the pin member, can be advanced axially in channel 68B until its head becomes engaged with the segment 63′. Alternatively, if desired, the screw 83′ can be removed after fasteners such as screws 67′ have been engaged and mount the leaf 60′.

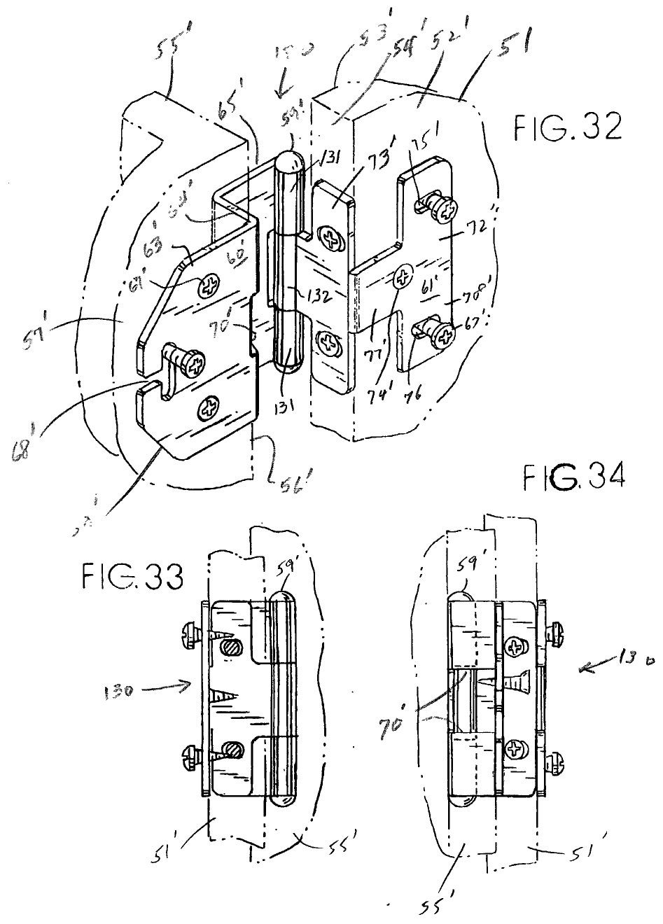

Shown in FIGS. 32-34 is another embodiment 130 of the inventive hinge. Portions of hinge 130 are somewhat similar to portions of hinge 50 and corresponding portions are similarly numbered but with the addition of prime marks for identification purposes.

A principal distinction between hinge 130 and hinge 50 is that hinge 130 incorporates a total of three knuckles, identified as two longitudinally spaced knuckles 131 that are integral with the open side edge of third segment 65′ of the first hinge leaf 60′ and a single knuckle 132 that is integral with the open side edge of the second segment 73′ of second hinge leaf 61′ and that is located between the knuckles 131.

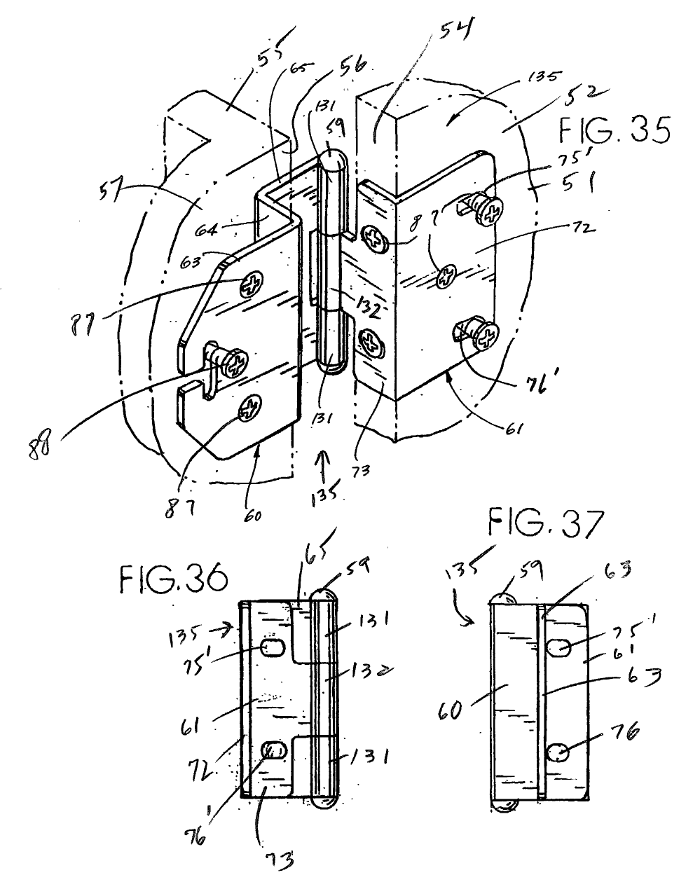

Shown in FIGS. 35-37 is another embodiment 135 of the inventive hinge. Some parts of hinge 135 are similar to parts of hinge 50 and corresponding parts are similarly numbered but with the addition of prime marks.

A principal distinction between hinge 135 and hinge 50 is that hinge 135 incorporates a segment 64′ in first leaf 60′ that does not include any opening (such as opening 70 in segment 64 in hinge 50) and segment 72′ in second leaf 61′ extends continuously (and does not include forward and rearward regions 77 and 78 as in segment 72 of second leaf 61 in hinge 50). When hinge 135 is in its closed configuration, the second segment 73′ of second leaf 61′ is located adjacent to the third segment 65′ of the first leaf 60′ and the second segment 64′ of the first leaf 60′ is located adjacent to a portion of the first segment 72′ of the second leaf 61′. The hinge 135 employs three knuckles, knuckles 131 of leaf 60′ and knuckle 132 of leaf 60′. The hinge 135 is preliminarily associated with screws 87 and 88 as illustrated in FIG. 1A for hinge 50.

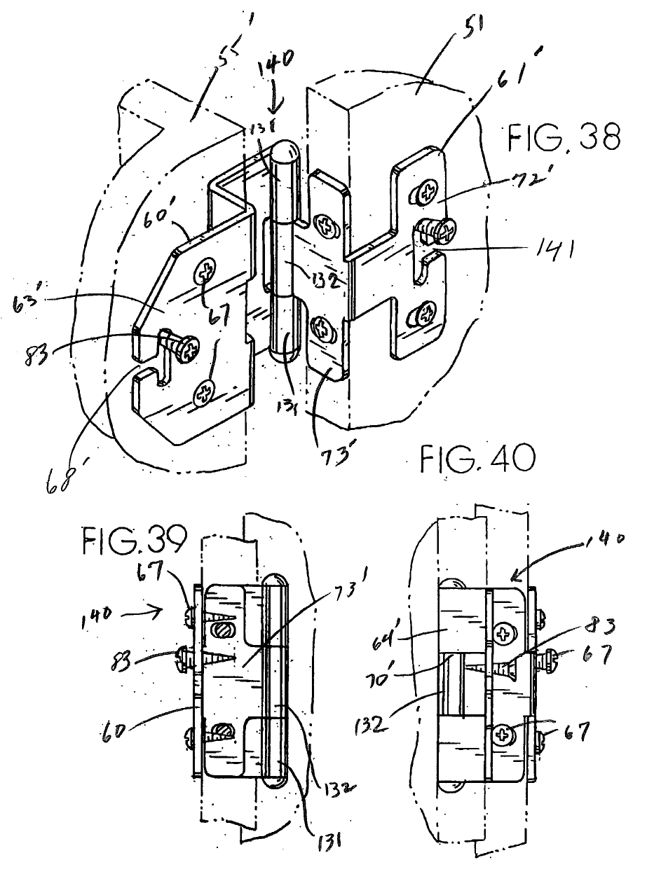

Shown in FIGS. 38-40 is another embodiment 140 of the inventive hinge. Some parts of hinge 140 are similar to parts of hinge 50 and corresponding parts are similarly numbered but with the addition of prime marks.

A principal distinction between hinge 140 and hinge 50 is that hinge 140 incorporates two elongated channels, one channel 68′ in the first segment 63′ of the first hinge leaf 60′ and one channel 141 in the first segment 72′ of the second hinge leaf 61′. The configuration and function of each of the channels 68′ and 141 is comparable to that of channel 68 in embodiment 50, above described. The channel 141 provides more versatility for the hinge 140 relative to the hinge 50. Thus, a person, if desired (but not detailed), could first mount the first hinge leaf 60′ to a cabinet 55′ and then mount the second leaf hinge 61′ to a cabinet door 51′ using the channel 141 to mount the door 51′ without the need for a second person to hold, align and position the cabinet door 51′. The hinge 140 incorporates three knuckles as in the hinge 135 which are similarly numbered as 131 and 132. The hinge 140 employs screws, such as screws 67, but alternatively could be preliminarily associated with screws 87 and 88 as illustrated in FIG. 1A for hinge 50.

Shown in FIGS. 41-43 is another embodiment 150 of the inventive hinge. Some parts of hinge 150 are similar to parts of hinge 50 and corresponding parts are similarly numbered but with the addition of prime marks for identification purposes.

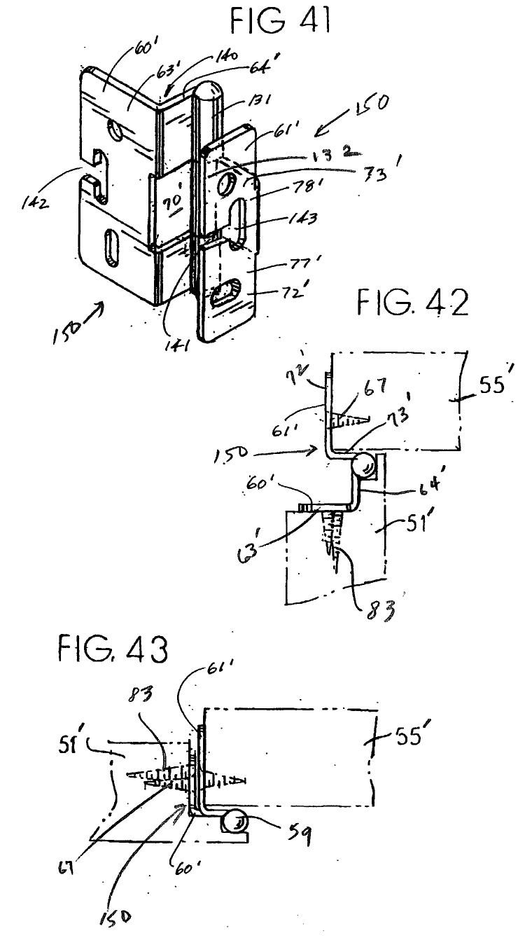

Principal distinctions between hinge 150 and hinge 50 are: (1) The hinge 140 has a first hinge leaf 60′ that incorporates only two (and not three) segments that are identified, respectively, as first segment 63′ and second segment 64′ while the second hinge leaf 61′ incorporates first and second segments 72′ and 73′, respectively. (2) The second segment 73′ of the second hinge leaf 61′ is narrow and is received in the opening 70′ defined in the second segment 64′ of the first hinge leaf 60′ when the hinge 150 is in a fully closed configuration. (3) Each of the leaves 60′ and 61′ are provided with a channel 142 and 143, respectively. The channels 142 and 143 each function similarly to the channel 68 provided in the hinge 50, above described. (4) The channels 142 and 143 in embodiment 140 are relatively further inset on their respective segments 63′ and 72′ than is the channel 68 in embodiment 50 on segment 63. The hinge 150 employs three knuckles, knuckles 131 of leaf 60′ and knuckle 132 of leaf 60′. The hinge 150 here employs screws, such as screw 67 and screw 83, as shown in FIGS. 42 and 43.

The hinge 150 enjoys applications that may be distinguished from those for hinge 50, for example. Thus, for example, and as illustrated in FIGS. 42 and 43, the hinge 140 can be associated with a cabinet and a cabinet door so that the hinge 140 is essentially hidden from view when seen in front elevation exteriorly when the hinge 140 is in a fully closed configuration in association with a cabinet 55′.

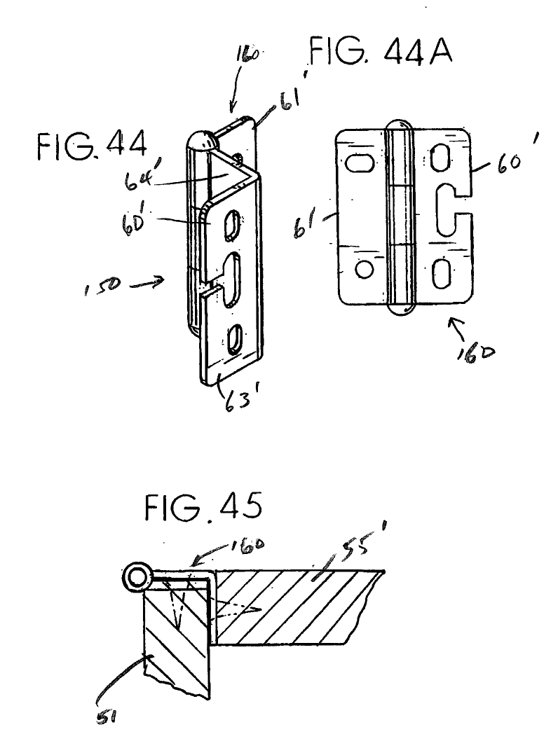

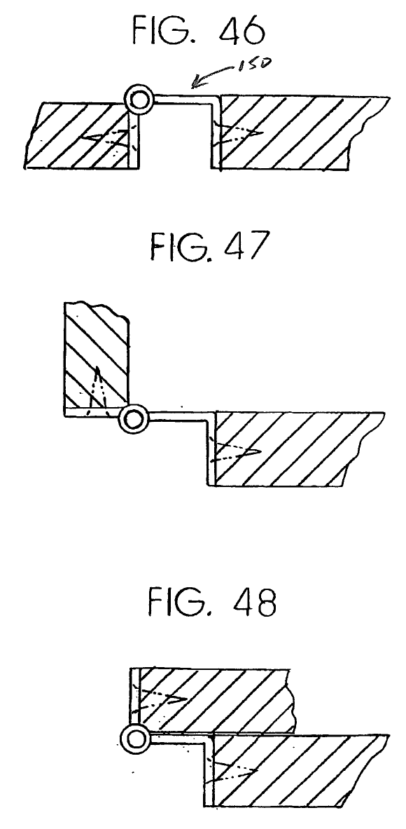

Shown in FIGS. 44-48 is another embodiment 160 of the inventive hinge. Some parts of hinge 160 may be considered to be similar to parts of hinge 50 and corresponding parts are similarly numbered but with the addition of prime marks.

Principal distinctions between hinge 160 and hinge 50 are: (1) The hinge 160 has a first hinge leaf 60′ that incorporates only two (and not three) segments identified, respectively, as first segment 63′ and second segment 64′. (2) The hinge 160 has a second hinge leaf 61′ that incorporates only one (and not two) segments. (3) No portion of the second hinge leaf 61′ is nestably received within any portion of the first hinge leaf 60′ when the hinge 160 is in a fully closed configuration. (4) In the hinge 160, the second hinge leaf 61′ is received against the face of the second segment of the first hinge leaf 60′ when the hinge 160 is in a fully closed configuration.

The hinge 160 enjoys applications that may be distinguished from those for hinge 50, for example. Thus, the hinge 150, as illustrated in FIGS. 44-47 permits a cabinet door 51′ to pivot through 270° relative to a cabinet aperture from a door closed position (shown in FIG. 45) to a door fully open position (shown in FIG. 48). The segment 64′ of L-shaped leaf 60′ upstands from the segment 63′ that is illustratively attached by screws, such as screws 67, to edge portions of an aperture in the cabinet 55′.

Shown in FIGS. 49-51 is another embodiment 170 of the inventive hinge. Some parts of hinge 170 may be considered to be similar to some parts of hinge 50 and corresponding parts are similarly numbered but with the addition of prime marks.

Principal distinctions between hinge 170 and hinge 50 relate to the circumstance that each of the hinge leaves 60′ and 61′ of hinge 170 contains only one flat segment. However, each leaf 60′ and 61′ contains a channel, these channels being identified as 161 and 162, respectively. The channels 161 and 162 function similarly to the channel 65 in hinge 50, above described. While the hinge 160, with its flat leaves 60′ and 61′, does not enjoy the positioning and locating features that are achieved by placing a channel, such as channel 68, in a sectioned hinge leaf, such as in leaf 60 in hinge 50, where a second leaf section extends over a corner and thereby enhances the locating and positioning capacity of associating a channel defined in an adjacent first leaf section with a prelocated and installed pin member, as described above. Still a hinge 170 with two flat leaves, such as provided, can achieve similar advantages of installability by only one worker through the use of one or more of the channels 161 and 162 defined therein.

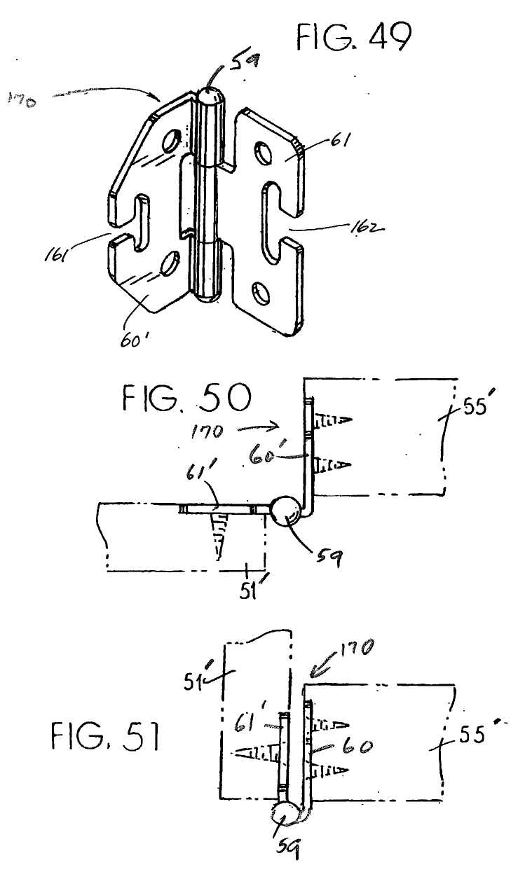

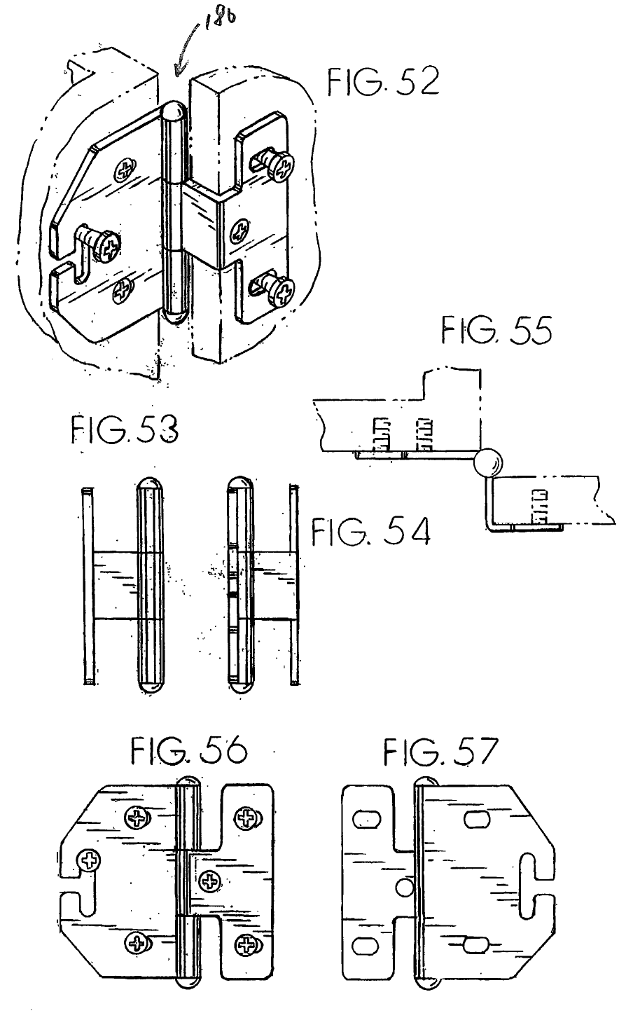

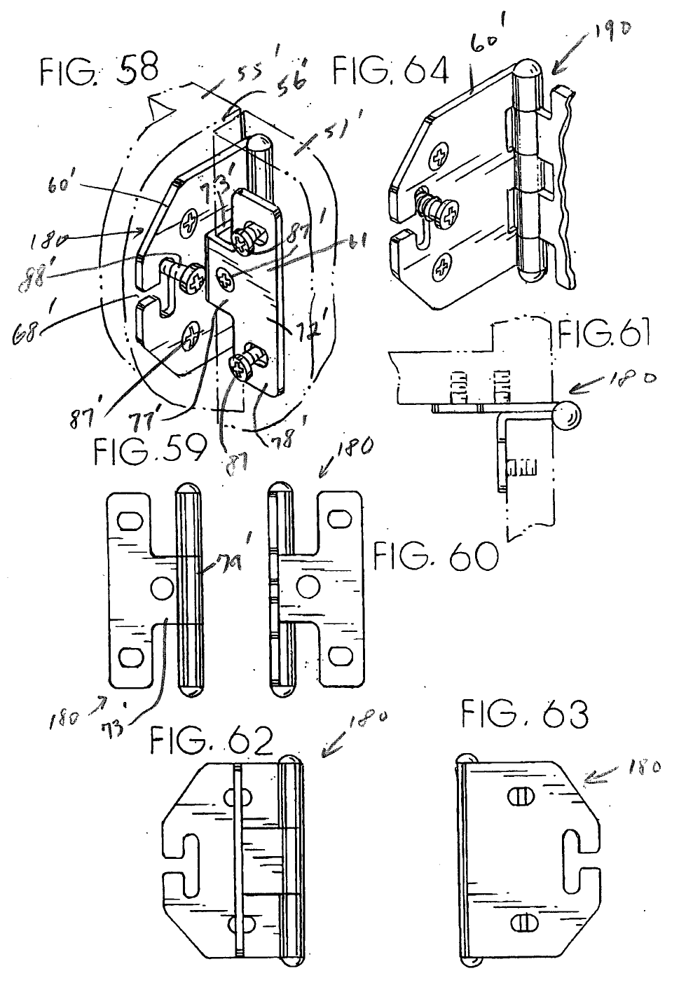

Shown in FIGS. 52-63 is another embodiment 180 of the inventive hinge. Some parts of hinge 180 may be considered to be similar to some parts of hinge 50 and corresponding parts are similarly numbered but with the addition of prime marks.

Principal distinctions between hinge 180 and hinge 50 involve the circumstance that in hinge 180 hinge leaf 60′ is flat while hinge leaf 61′ is L-configured and comprises two segments 72′ and 73′ that are edge connected and perpendicular to one another. No portion of hinge leaf 61′ is nestably received in any portion of hinge leaf 60′. The longitudinal extent of segment 73′ corresponds to the longitudinal extent of the single associated knuckle 79′, and the width of the segment 73′ is chosen to accommodate the edge portion of a connected cabinet door 51′. The segment 73′ joins the segment 72′ in a forward region 77′ of the segment 72′, and the longitudinal width of the segment 73′ corresponds to the longitudinal width of the region 77′ of the segment 72′. The forward region 77′ joins medially the rearward region 78′ of the segment 72′, and the longitudinal length of the rearward region 78′ of the segment 72′ is substantially greater than that of the forward region 77′, as in the segment 72 of the hinge 50. The leaf 60′ is provided with an elongated channel 68′, as in the hinge 50. The channel 68′ is preferably preliminarily associated with a screw 88′, and the leaf holes 66′, 74′, 75′, and 76′ are each preferably preliminarily associated with a screw 87′. The hinge 180 is adapted for use as a so-called inset hinge where a cabinet door 51′ may be inset relative to the aperture 56′ of a cabinet 55 in contrast to the hinge 50 that is adapted for use as a so-called overlay hinge where a cabinet door 50 may overlap edge portions, if desired, of a cabinet 55 aperture 56.

Shown in FIG. 64 is another embodiment 190 of the inventive hinge. Some parts of hinge 190 may be considered to be similar to some parts of hinge 50 and corresponding parts are similarly numbered but with the addition of prime marks.

A principal distinction between hinge 190 and hinge 180 lies in the circumstance that the hinge 190 is provided with five knuckles instead of three knuckles as in the hinge 170.

Various other embodiments, applications, features, alternative but equivalent structures, and the like will be apparent to those skilled in the art from the present description of the invention and no undue limitations are to be drawn therefrom.

What is claimed is:

1. A hinge for hanging a cabinet door relative to a cooperating aperture defined in a cabinet, said hinge comprising first and second hinge leaves with respective knuckle portions that are pivotable relative to an associated pintle and wherein said first hinge leaf includes a channel defined therein that is engageable with a positioning and supporting support.

2. A hinge for pivotably mounting a pivotable member at an aperture in a stationary structure for enabling one worker to mount said hinge to said stationary member after said hinge is mounted to said pivotable member, said hinge comprising:
a hinge pintle;
a first and a second hinge leaf, each leaf having knuckle means for pivotable association with respective longitudinally adjacent portions of said pintle whereby each leaf is pivotable relative to the other about said pintle;
said first hinge leaf further having defined therein an outwardly opening channel;
whereby, when said second hinge leaf is connected to said pivotable member, said second leaf can be preliminarily suspended at said stationary member by associating said channel in said first hinge leaf with a premounted support means located in said cabinet.

3. The hinge of claim 2 wherein each of said first and said second hinge leaves additionally has hole means defined therethrough for receipt therethrough of mounting means.

4. The hinge of claim 3 wherein said mounting means comprises screw members each of which has a threaded shank portion of generally uniform diameter, and wherein each said hole means is threadably preliminarily associated with an outer end region of said threaded shank portion.

5. The hinge of claim 2 wherein each of said second hinge leaf also has defined therein an outwardly opening channel whereby either of said first or said second hinge leaves can be preliminarily connected to said pivotable member after which the other said hinge leaf can be so preliminarily suspended at said stationary member by said channel therein.

6. The hinge of claim 2 wherein said first hinge leaf additionally defines progressive interconnected first and second flattened segments, said second segment extends perpendicularly relative to said first segment, said channel is defined in said first segment, and said knuckle means is defined along a side edge of said second segment.

7. The hinge of claim 6 wherein said second hinge leaf additionally defines progressive first and second flattened portions, said second portion extends perpendicularly relative to said first segment, and said knuckle means is defined along a side edge of said second segment.

8. The hinge of claim 6 wherein each of said first and said second hinge leaves additionally has hole means defined therethrough for receipt therethrough of mounting means.

9. The hinge of claim 2 wherein said first hinge leaf additionally defines progressive interconnected first, second and third respective flattened segments, said second segment extends perpendicularly relative to said first segment, said third segment extends perpendicularly relative to said second segment and parallel to said first segment, said channel is defined in said first segment, and said knuckle means is defined along a side edge of said third segment.

10. The hinge of claim 9 wherein said second hinge leaf additionally defines progressive first and second flattened portions, said second portion extends perpendicularly relative to said first portion, and said knuckle means is defined along a side edge of said second portion.

11. The hinge of claim 10 wherein each of said first and said second hinge leaves additionally has hole means defined therethrough for receipt therethrough of mounting means.

12. The hinge of claim 10 wherein said second segment has an opening medially defined therein, and said first portion defines first and second transversely adjacent regions, said second region being adjacent to said second portion and having a reduced length relative to said first region, whereby, when said hinge is in a closed configuration, said second portion is adjacent to said third segment, and second region is received in said opening.

13. The hinge of claim 2 wherein said knuckle means of said first hinge leaf comprises three knuckles and said knuckles means of said second hinge leaf comprises two knuckles that are interdigitated between said three knuckles.

14. The hinge of claim 2 wherein said knuckle means of said first hinge leaf comprises two knuckles and said knuckles means of said second hinge leaf comprises one knuckle that is interdigitated between said two knuckles.

15. The hinge of claim 2 wherein said first hinge leaf additionally has defined therein a second outwardly opening channel.

16. A hinge adapted for use in hinging a cabinet door relative to an aperture in a cabinet for swinging movements of said door between open and closed hinge positions relative to said aperture, said door having respective inside and outside faces and a back side edge, said cabinet including a side piece means located along said aperture and adjacent said back side edge, said hinge comprising:
a hinge pintle;
a first hinge leaf comprising progressive, interconnected first, second, and third respective flattened segments,
said first segment having a perimeter region that defines therein an outwardly opening channel, and having holes defined therethrough for receipt therethrough of mounting means,
said second segment extending perpendicularly relative to said first segment, said second segment being of sufficient length and width to overlie an edge region of said side piece means, and said second segment having an opening medially defined therein,
said third segment extending perpendicularly relative to said second segment and parallel relative to said first segment,
said third segment including first knuckle means for receiving said pintle, said first knuckle means being located along an outer edge region of said third segment and extending parallel to said second segment,
said third segment being of sufficient length to overlie said back side edge and being of sufficient width to locate said first knuckle means outwardly relative to said outside face when said hinge is in said closed hinge position,
a second hinge leaf comprising progressive, interconnected first and second respective flattened portions,
said first portion defining first and second transversely adjacent regions, said second region being adjacent to said second portion and having a reduced length relative to said first region, and said first region having holes defined therethrough for receipt therethrough of mounting means;
said second portion extending perpendicularly relative to said first portion, and said second portion being of sufficient length and width to overlie an edge region of said back side edge,
said second portion including second knuckle means for receiving said pintle, said second knuckle means being located along an outer edge region of said second segment and extending parallel to said first segment, and said second knuckle means being longitudinally aligned with said first knuckle means,
said pintle extends longitudinally through said first and said second knuckle means for enabling pivotable movement of said first hinge leaf relative to said second hinge leaf about said pintle,
the interrelationship between said first and said second hinge leaves being such that when said hinge is in said closed hinge position—
said second portion is adjacent said third segment, and
said second region is received within said opening;
whereby, when said when said second leaf member is connected to said door by said mounting means, said hinge and the so connected said door can be suspended by said first leaf member by associating said channel with a premounted support means located in said cabinet.

17. The hinge of claim 16 wherein said first knuckle means comprises three knuckles and said second knuckle means comprises two knuckles that are interdigitated between said three knuckles.

18. The hinge of claim 16 wherein said first hinge leaf includes a single said channel that is generally T-shaped when viewed in side elevation.

19. The hinge of claim 18 wherein said single channel has a leg portion that connects with said perimeter region and that extends generally perpendicularly relative to an edge defining portion of said cabinet aperture.

20. The hinge of claim 16 wherein said first hinge leaf includes two of said channels.

21. The hinge of claim 20 wherein said perimeter region and said channels are configured so that said channels extend generally perpendicularly relative to each other.

22. The hinge of claim 16 wherein said second region has at least one hole defined therethrough for receipt therethrough of mounting means.

23. The hinge of claim 16 wherein said second portion has at least one hole defined therethrough for receipt therethrough of mounting means.

24. The hinge of claim 16 wherein at least some of said holes are elongated so as to permit said hinge to be adjustably positioned relative to said mounting means that are so received through said holes.

25. The hinge of claim 24 wherein at least some of said holes are elongated so as to permit said hinge to be adjustably positioned relative to said mounting means that are so received through said holes.

26. The hinge of claim 16 wherein at least some of said holes are each adapted to receive therethrough and threadably matingly engage at least portions of the threaded shank of a screw member.

27. The method of hinging a pivotable member relative to a cooperating aperture defined in a stationary structure with a hinge that comprises first and second hinge leaves each with knuckles that are interdigitated relative to each other, and a knuckle associated pintle and wherein said first leaf includes a positioning channel defined therein, said method comprising the steps of:
(a) selecting an approximate location on each of said pivotable member and said stationary structure at said aperture where said hinge is to be mounted;
(b) preliminarily mounting a support member at said stationary structure location;
(c) mounting said second hinge leaf at said pivotable member location;
(d) placing said channel over said support member, thereby suspending said pivotable member from said stationary structure by said first hinge leaf; and
(e) mounting said first hinge leaf to said stationary structure at said stationary structure location.

28. The method of claim 27 wherein said mounting is achieved by screw means.

29. The method of claim 27 wherein said support member comprises a headed screw member that projects outwardly from said stationary structure.

30. The method of claim 27 wherein said pivotable member comprises a door and said stationary structure comprises a cabinet.

31. The method of claim 30 wherein said door and said cabinet are each provided with predrilled holes, and said support member comprises a headed screw member that utilizes a predrilled hole, and said mounting of each of said first and said second hinge leaves is achieved by screw means that utilize said predrilled holes.

32. The method of claim 27 wherein each of said first and said second hinge leaves additionally has a plurality of hole means defined therethrough for receipt therethrough of respective mounting means, and said mounting means mounts said hinge leaves.

33. The method of claim 32 wherein each said mounting means comprises a screw member which has a threaded shank portion of generally uniform diameter, and wherein each said hole means is threadably preliminarily associated with an outer end region of said threaded shank portion of a different said screw member.

34. The method of claim 31 wherein, after said first hinge leaf is so mounted, said support member is removed.

35. The method of claim 30 wherein, after said second hinge leaf is so mounted, said support member is advanced into said cabinet and engagement with said second hinge leaf, thereby to aid in mounting said second hinge leaf to said cabinet.

36. A method for hanging a cabinet door relative to a cooperating aperture defined in a cabinet with a hinge as defined in claim 1, said method comprising the steps of:
(a) selecting an approximate location on each of said door and said cabinet where said hinge is to be mounted;
(b) preliminarily mounting a support member for said channel at a position in said so selected location at said cabinet where said channel in said first hinge leaf will be located when said cabinet door and said cabinet have been connected together by said hinge with said first and second hinge leaves being located in said selected locations;
(c) mounting said second hinge leaf to said cabinet door in said selected location employing a plurality of headed fastening members that each extend through different respective holes defined in said second hinge leaf into adjacent portions of said door;
(d) placing said channel over said support member, thereby positioning and supporting said cabinet door and said hinge as so mounted to said cabinet door by said first hinge leaf; and
(e) mounting said first hinge leaf to said cabinet with said first hinge leaf being so positioned and supported relative to said cabinet employing a plurality of headed fastening members that each extend through different respective holes defined in said first hinge leaf into adjacent portions of said cabinet.

37. The method of claim 36 wherein said head fastening members comprise screws.

38. The method of claim 36 wherein said support member comprises a screw that projects outwardly from said cabinet.

39. The method of claim 36 wherein said first hinge leaf is so mounted to said cabinet door by said headed fastening members that extend into predrilled receiving holes defined in said door.

40. The method of claim 36 wherein said second hinge leaf is so mounted to said cabinet by said headed fastening members that extend into predrilled receiving holes defined in said cabinet.

41. The method of claim 40 wherein, after said second hinge leaf is so mounted, said support member is removed.
